(19) United States
(12) Patent Application Publication
(10) Pub. No.: US 2017/0353325 A1
(43) Pub. Date: Dec. 7, 2017

(54) UTILITY GATEWAY

(71) Applicant: VODAFONE IP LICENSING LIMITED, Newbury, Berkshire (GB)

(72) Inventors: Fred MATTIG, London (GB); Andy HAIG, London (GB); Richard BAILEY, London (GB)

(21) Appl. No.: 15/536,235

(22) PCT Filed: Dec. 16, 2015
(86) PCT No.: PCT/EP2015/079980

§ 371 Date: Jun. 15, 2017

(30) Foreign Application Priority Data
Dec. 17, 2014 (GB) 1422425.7

(51) Int. Cl. H04L 12/28; G01D 4/00; H04L 29/06

(52) U.S. Cl. CPC H04L 12/2818; H04L 63/0823; G01D 4/004; H04L 29/06

(57) ABSTRACT

A remote gateway and method for managing a network of utility meters, the remote gateway forming part of a system comprising one or more utility management components, a plurality of local gateways each adapted to communicate with one or more utility devices, the remote gateway comprising logic configured to communicate utility data between the plurality of local gateways and the one or more utility management components over one or more secured wide area networks, WANs. Manage digital certificates for certifying the communicated utility data.

### FIELD OF THE INVENTION

The present invention relates to a system and method for managing a network of utility devices and in particular a network of smart meters.

### BACKGROUND OF THE INVENTION

In order to charge for utilities such as electricity, gas and water, utility companies install utility meters and other devices at the point of delivering the utility to each property. Manually reading utility meters has an associated cost and is inconvenient. Smart metering has developed to transmit metering data from the property to a meter data management system. Whilst this is an improvement over simple utility meters, additional services and capabilities have developed for smart metering. Furthermore, the inclusion of multiple different smart meters and energy management devices within a property has led to the development of hardware smart meter gateways that manage the meters and devices and interface with a local network for communicating these data to external parties such as the utility providers.

An example system 10 incorporating such a hardware-smart meter gateway (H-SMG) B1 is shown in FIG. 1.

In such a system 10, a home or business property 20 may contain several wired or wireless utility meters A1, A2 to form a smart meter network E1 as well as other related devices such as a boiler or microgenerator A5, a switchable load such as an air-conditioner A4 and a display unit A3 that form a home area network E2.

The H-SMG B1 in such a scenario may provides some or all of the following functions depending on the scope of the service offering by a Utility company to their customers:

Function:

1 (H-SMG). Termination of physical connections (ISO layer 1) and associated data link protocols (ISO layer 2) to smart meters. This may be wired connection A1 or wireless connection A2.

2 (H-SMG). Manage a secure Smart Meter network: both wired and wireless connections within the home, covering for example electricity, gas and heat. This involves authenticating access, and transport security.

3 (H-SMG). Manage secure Home Area Network of other energy related devices, such as:
(a) in-home display A3
(b) switchable loads A4 such as air-conditioner or heater,
(c) micro-generation capability A5, such as photovoltaic cells.

This may involve authenticating access, and transport security.

4 (H-SMG). Manage communication with remote parties over a Wide Area Network C1. Remote parties are those that consume data from the home, or provide commands to entities in the home. For example:
(a) Meter Data Management system D1 run by an Energy Retailer.
(b) Local system controllers D2, who control local systems A4, A5 in the home.
(c) Remote system for configuration of the H-SMG D3.

This may involve decision of what information to share with each remote party, authenticating access, and transport security.

5 (H-SMG). Meter data handling decisions: e.g. meter data upload schedule; managing ‘on-demand’ readings from remote parties.

6 (H-SMG). Calculation of customer charge: for example by receiving and using applicable tariff levels.

7 (H-SMG). Cryptographic operations:
(a) provide random numbers
(b) negotiate keys
(c) generate signatures
(d) check signatures

8 (H-SMG). Key generation & secure storage

(a) generate its own key pairs for communication over the WAN for: TLS (transport layer security), SIG (content data signature), ENC (content data encryption), and AUT (external authentication).
(b) create, manage and delete keys for smart meters.

9 (H-SMG). Certificate management:
(a) procure certificates from a certificate authority for its own public keys for communication over WAN: TLS (for secure channel), SIG (for signing data), ENC (for content level encryption)
(b) create, manage and delete certificates for smart meters.
(c) import certificates for communication with remote entities for: TLS, SIG, ENC, AUT.

However, this requires a large number of imported certificates. As utility data is personal data then it must be adequately protected. Furthermore, in certain countries, certificates used to protect such data must be issued by audited certificate authorities and refreshed at intervals. Therefore, the ongoing cost of these certificates can be significant, especially for large networks of smart meters. Additionally, the effort of remotely maintaining the H-SMG in each property can be significant and itself provide a drain on resources (e.g. computing and network bandwidth). Furthermore there are cost, stability and security implications associated with the complexity of the H-SMG.

Therefore, there is required a method and system that overcomes these problems.

### SUMMARY OF THE INVENTION

In general terms, instead of the H-SMG B1 being located at each property that receives utility services, this is replaced by a simple hub or local gateway that is in local communication with each utility meter, utility device and/or utility component. A function of this local gateway is to provide an endpoint for a secured wide area network, WAN, over which utility data are communicated (in either or both directions). A remote gateway or server smart meter gateway remote from the property communicates utility data to utility management components. This remote gateway may provide any one or more of the functions described with respect to the H-SMG B1 shown in FIG. 1. In other words, the remote gateway takes over the function of the H-SMG B1 to route the data but it is not physically located within the property. Therefore, one remote gateway can manage utility data from a plurality of properties. The utility data is certified so that instructions, meter readings or other information can be authenticated, secured, signed and/or encrypted. The certificates for achieving this are managed (and created and deleted) by the remote gateway. Whilst the remote gateway needs to obtain one or more certificates to certify its own communications, because one remote gateway can manage many properties this represents a cost, infrastructure and efficiency saving without compromising security.

In accordance with a first aspect there is provided a remote gateway for managing a network of utility devices and/or meters, the remote gateway forming part of a system comprising one or more utility management components, a plurality of local gateways each adapted to communicate with one or more utility devices and/or meters, the remote gateway comprising logic configured to:

communicate utility data and/or utility meter data between the plurality of local gateways and the one or more utility management components over one or more secured wide area networks, WANs; and

manage digital certificates for certifying the communicated utility meter data and/or utility meter data. The remote gateway may be between each of the local gateways and the one or more utility management components. The remote gateway may act as a WAN endpoint for each local gateway. Managing the digital certificates may involve generating certificates for each utility device or meter. These certificates may be generated from a seed or root certificate stored within the remote gateway, for example.

Advantageously, the logic may be further configured to obtain digital certificates for securing the one or more WANs. These digital certificates may be any one or more of TLS, SIG or ENC certificates, for example.

Preferably, each of the one or more local gateways may be in communication with a group of the plurality of utility devices or meters over a local network. This group may be for a single property (domestic or commercial).

Optionally, the remote gateway may be further configured to communicate with a server or communications server configured to secure a communication connection for communicating the utility data (and/or utility meter data) with the one or more utility management components. The server may be integral to or separate from the remote gateway.

Optionally, the logic may be further configured to obtain one or more digital certificates for securing the communication connection with the one or more utility management components. Obtaining may involve importing the certificates, for example.

Optionally, the WAN may be a cellular WAN or a cable WAN. Other WAN types may be used.

Optionally, the logic may be further configured to create, procure, manage and/or delete digital certificates for the plurality of utility meters or devices in communication with the local gateway(s).

According to a second aspect, there is provided a system comprising:

a remote gateway according to any embodiment described above;

one or more utility management components;

a server configured to secure a communication connection for communicating the utility data and/or utility meter data with the utility management components; and

a plurality of local gateways each adapted to communicate with one or more utility devices and/or utility meters.

Optionally, the utility management components may be any one or more of:

a data management component;

a system controller; and/or

a gateway configuration server.

Preferably, the remote gateway may communicate with each local gateway over a secured WAN.

According to a third aspect there is provided a method for managing a system comprising: a network of utility devices and/or meters, a remote gateway adapted to communicate with a plurality of local gateways each adapted to communicate with one or more utility devices and/or utility meters, and one or more utility management components, the method comprising the steps of:

communicating utility meter data between the plurality of local gateways and the one or more utility management components over one or more secured wide area networks, WANs; and

managing digital certificates for certifying the communicated utility data and/or utility meter data.

Optionally, the utility data and/or utility meter data may be any one or more of:

meter readings, an instruction for a utility meter to provide a meter reading, measurement of energy supply quality, an instruction to switch a load, domestic generation data, an instruction to reduce or increase the level of domestic generation to the grid, current utility usage, historic utility usage, tariff level, utility bill data, and utility data upload schedule.

Optionally, the method may further comprise the step of generating key pairs for securing the one or more WANs.

Optionally, managing the digital certificates for certifying the utility meter data may further comprise importing digital certificates from the one or more utility management components.

Advantageously, the method may further comprise the step of procuring from a certificate authority digital certificates for signing, encrypting and/or authenticating the utility data and/or utility meter data.

Optionally, the utility devices may be all or in part utility meters and the utility data may be at least in part utility meter data.

Optionally, the remote gateway may contain a data store for storing static and/or dynamic data.

Optionally, the data store may also or alternatively store obtained and/or generated certificates.

Preferably, the data store may be a hardware security module or other secure component.

The methods described above may be implemented as a computer program comprising program instructions to operate a computer. The computer program may be stored on a computer-readable medium.

The computer system may include a processor such as a central processing unit (CPU). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operating system such as UNIX, Windows (RTM) or Linux, for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a system for managing utility meters, according to the prior art;

FIG. 2 shows a schematic diagram of a system for managing utility meters, given by way of example, only; and

FIG. 3 shows a schematic diagram of a method for managing utility meters, given by way of example only.

It should be noted that the figures are illustrated for simplicity and are not necessarily drawn to scale. Like features are provided with the same reference numerals.

### DETAILED DESCRIPTION OF THE PREFERRED EMBODIMENTS

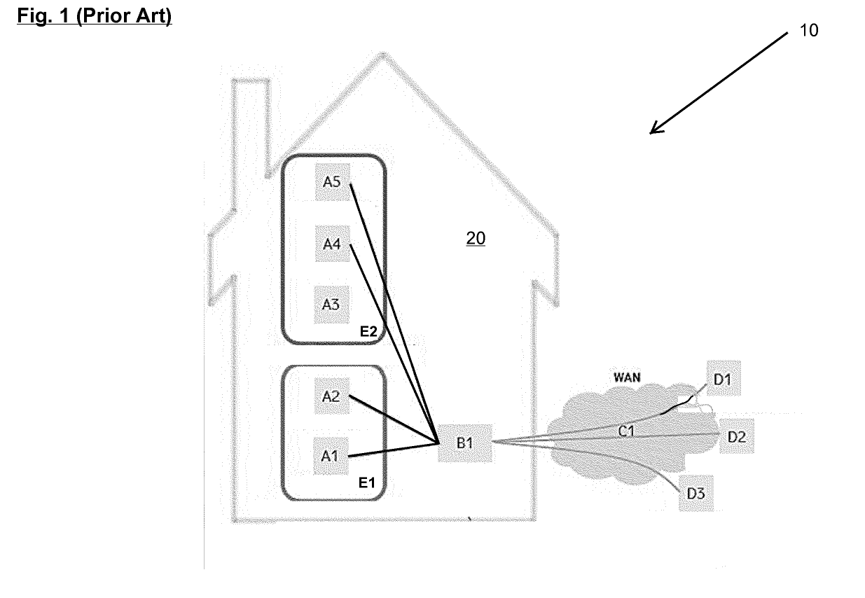

The high level of functionality associated with the H-SMG B1 of FIG. 1, and the high expected volumes of H-SMGs (typically one in each home, which depending on the size of the Utility can be 100,000 s to millions of devices) leads to a number of problems:

high cost and complexity of procuring certificates: in some markets, particularly Germany, certificates must meet high national security levels and can only be procured from appropriately certified Root CA.
high operational costs and certificate management: the H-SMG B1 may require multiple digital certificates covering transport security, signing data, encrypting content object, key transport, and these need to be updated at intervals (e.g. every 18 months).
system vulnerability: a complex hardware item in the home can present a vulnerability in the system (e.g. in case of its failure) and because it acts as a local storage point of meter data and recipient of demand control commands. Significant effort has to be made to prevent, detect and report tamper attacks by customers and other parties.
Hardware Security Module (HSM) in the H-SMG: depending on the security requirements of the Utility provider, it may be necessary to store private keys using an HSM. This may again increase the cost and complexity of the H-SMG B1.
Firmware update load: necessity to maintain firmware updates of complex functionality of the H-SMG may cause high load to the WAN, and logistical problems with managing downloads without causing network congestion.
Overall H-SMG B1 cost: in some markets the functionality needed for the box can be high, leading to high capital costs to the Utility for installation.

These drawbacks and problems may be improved by the present solution. A remote gateway or smart meter gateway is provided to manage devices in the home and in particular those devices operating within regulatory constraints that place high security requirements on the system. The replacement home device itself is smaller, cheaper and dumber, with the intelligence centralised at the remote gateway.

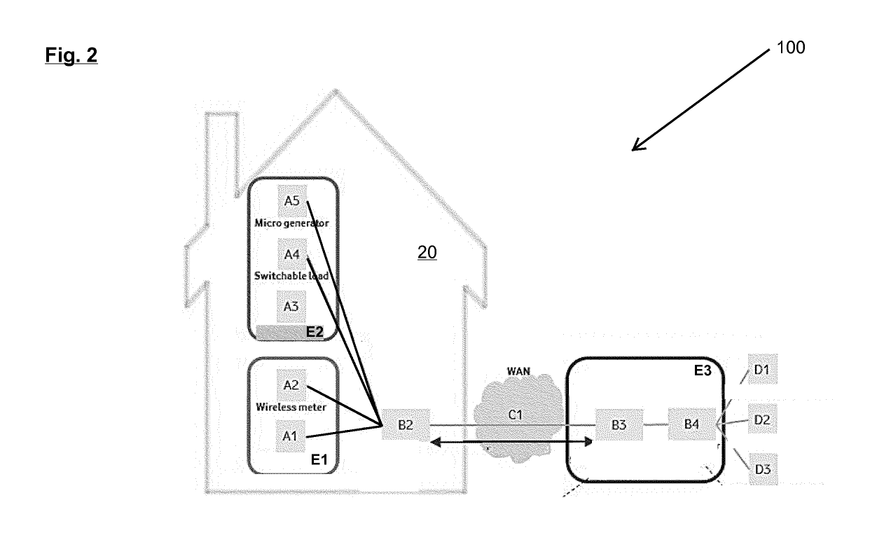

A new network entity, the remote gateway or Server based smart meter gateway, S-SMG (represented by B3 in FIG. 2), may run within a data centre E3, and performs the functionality typically provided by a H-SMG B1, except for termination of the physical layer and link layers.

A lower complexity hub or local gateway B2 is introduced within the property 20. The local gateway B2 establishes a permanently connected IP tunnel C2 over a WAN C1 to the remote gateway B3. Several variations may be used, including:

(a) if a cable WAN is used, then the local gateway B2 may be represented by a cable modem and the IP tunnel may be achieved using a DOCSIS (Data Over Cable Service Interface Specification) service flow from the cable modem, for example.

(b) if a cellular WAN is used, then the local gateway B2 may be a cellular M2M device, for example using 2G, 2G+, 3G or LTE radio access network, and the IP tunnel may be achieved using IPsec protocol, for example.

Functions of the local gateway B2 may include any one or more of:

1. PHY and data link connections to utility meters and/or utility devices.

10. Relaying of protocols above data link layer.

9. Certificate management:
(a) procure single certificate for TLS
(b) import single certificate for B3 for TLS

Functions of the remote gateway B3 may include any one or more of:

2. Manage secure smart meter network.

3. Manage secure home area network (HAN).

4. Manage WAN communications with utility management components D1, D2, D3.

5. Meter data handling decisions.

6. Calculation of customer charges.

7. Cryptographic operations.

8. Key generation and secure storage:
(a) own key pairs for WAN communications
(b) key pairs used by smart meters

9. Certificate management:
(c) procure own certificates for TLS, SIG, ENC
(d) create, manage and delete certificates for smart meters.
(e) import content level certificates for utility management components D1, D2, D3 for SIG, ENC, AUT.

A communications component or server B4 may be part of the remote gateway B3 or be a separate device. This communications component B4 may have any or all of the following functionality:

9. Certificate management:
(f) procure its own certificates for TLS
(g) import transportation certificates for utility management components D1, D2, D3 for TLS.

Therefore, the local gateway B2 now only needs certificates to secure the IP tunnel (e.g. the procurement of its own certificate for TLS, represented by function 9(a), and import of the TLS certificate of the S-SMG, represented by function 9(b)).

Smart meters and other devices (e.g. home display A3, switchable load A4, micro generator A5) in the home (e.g. any wired meters A1, or wireless meters A2) may remain unchanged (when compared with the system 10 of FIG. 1). These devices A1-A5 may connect to the local gateway B2, using existing wired or wireless physical and data link connections, as if they were connecting to the H-SMG B1 of FIG. 1.

The local gateway B2 may receive messages from smart meters A1, A2, and other energy devices in the home A3, A4, A5, and forwards these messages over the established IP tunnel C2 to the remote gateway B3.

Likewise, the local gateway B2 may receive messages from the remote gateway B3 over the established IP tunnel C2 and forward these over a smart meter network E1 (i.e. a local network of utility meters) or a home area network E2 (i.e. a local network of other devices) to the utility meters or energy devices in the home (A1-A5).

To achieve this, the local gateway B2 terminates the physical layer (ISO layer 1) and associated data link layer protocols (ISO layer 2) towards the smart meters and other energy devices (function 1). This can include but is not restricted to the following:
RS-485+HDLC (High-Level Data Link Control)
Wireless M-Bus (EN 13757-4)
IEEE 802.15.4 (sub-GHz or 2.4 GHz)

The local gateway B2 may use the IP tunnel C2 to relay protocol messages received, between the devices A1-A5 and the remote gateway B3 (function 10). This includes but is not limited to the following protocols:
TLS
OMS (Open Metering System) security—AFL (Authentication and Fragmentation Layer)
M-Bus (EN 13757-3), including security and application layer
SML (Smart Message Language, defined in IEC 62056-5-3-8)
DLMS/COSEM (Device Language Message Specification/Companion Specification for Energy Metering) (IEC 62056-6-2)

The secure Smart Meter network in the home E1 may be managed remotely by the remote gateway B3. This is represented by function 2. This may be achieved by termination within the remote gateway B3 of the transport security protocols (e.g. TLS) used by smart meter devices A1, A2. This may include authentication of access from devices A1, A2. It also may include the ability of the remote gateway B3 to create, manage and delete certificates for smart meters (A1, A2), represented by Function 9(d). These digital certificates may be generated from a root certificate or otherwise obtained.

Similarly, the secure Home Area Network E2 may be managed remotely by the remote gateway or server B3. This is represented by function 3. This may be achieved by termination within the remote gateway B3 of the transport security protocols (e.g. TLS) used by HAN devices (A3, A4, A5). This may include authentication of access from devices A3, A4, A5.

Cryptographic operations no longer carried out by the H-SMG B1 of FIG. 1 and these are now carried out by the remote gateway B3. This is represented by function 7. This may include the following procedures:
(a) generation of random numbers
(b) negotiation of keys
(c) generation of signatures
(d) verification of signatures

This may be achieved by implementing application layer security within the remote gateway B3 rather than the H-SMG B1. An advantage of this is that the local gateway in the home (or other property) no longer needs to implement a (hardware) secure module, which leads to a saving in complexity and cost.

Generation of key pairs and their secure storage may be performed by the remote gateway B3. This is represented by function 8. This may include any one or more of the following procedures:

(a) generation of own key pairs for communication over the WAN for: TLS, SIG (content data signature) and ENC (content data encryption)

(b) creation, management and deletion of key pairs used by the smart meters.

Aspects of communication to remote parties may also be handled remotely the (one or more) remote gateway B3, as opposed to being handled by the SMG device in the home (H-SMG B1 shown in FIG. 1). This may be represented by functions 4, 9(c), 9(e), 9(f) and 9(g) above.

Remote parties may be those that consume data from the home, or provide commands or data to entities in the home. For example:
(a) Meter Data Management system D1 operated by the Energy Retailer.
(b) Local system controllers D2, who control local systems in the home A4, A5.
(c) Remote system for configuration of the remote gateway D3.

To achieve this, the following steps may be taken:

(1) key pairs for WAN communication may be generated by the remote gateway B3 (as mentioned in function 8(a) above)

(2) certificates may be procured from a certificate authority at the remote gateway B3 from a certificate authority for content level security (SIG representing a certificate for signing content, and ENC representing a certificate for encrypting content). This is represented by function 9(c) above.

(3) certificates may be imported at the remote gateway B3 representing remote parties D1, D2, D3 for operations at the application level (SIG representing a certificate for signing content, ENC representing a certificate for encrypting content, and AUT representing a certificate for external authentication). This is represented by function 9(e) above.

(4) a dedicated communications component or server B4 may be used to handle traffic from one or more remote gateway B3 instances (which in turn represent data from a plurality of homes) towards the remote communications parties D1, D2, D3. This may involve the handling of authenticating access, and transport security for the remote parties. The communications component or server B4 can achieve secure transport towards the remote entities using a single public key to represent itself (function 9(f) above), rather than needing a separate public key to represent each household or property. It can manage the installation of transport level certificates for remote parties D1, D2, D3—represented by function 9(g) above, which may be logistically easier to manage than installing these at potentially millions of instances of devices in the home.

Meter data handling decisions may now be performed remotely by a network server, i.e. the remote gateway B3. This is represented by function 5 above. This includes decisions to schedule readings taken from the smart meters A1, A2, and to schedule the upload of readings to remote parties (e.g. D1, D3), and managing of ‘on-demand’ reading commands from remote parties (e.g. D1).

The remote gateway B3 may also provide one or more functions including:
(a) calculation of the customer charge explicitly for the purpose of display on the ‘home display’ A3, and
(b) sending of the calculated charge to the home display A3 using for example DLMS/COSEM.

This is represented by function 6 above.

The functionality level of a local gateway B2 is lower than an H-SMG B1. For example, a hardware security module may not be require in the local gateway B2. This may reduce cost and implementation complexity.

The operating cost (in computing requirements, network requirements and financial terms) of the system 100 (see FIG. 2) may be reduced. The functionality may be achieved using fewer (or only a single certificate at the local gateway B2) in order to secure the IP tunnel C1. The system (FIG. 1) of an H-SMG typically involves the procurement of multiple certificates that may have to meet a high level of national or regulatory security requirements.

Multi-tenancy: To improve efficiency and reduce system complexity it may be advantageous to implement a multi-tenanted concept—i.e. multiple households or properties may be served from a single device. However, this can be difficult to implement and manage in practice. Therefore, utility companies may resort to a 1:1 ratio of deployment of smart meter gateway (SMG) per household or property. This may be due to planning complexity (i.e. logistically easier to assume one SMG per household or property). However, the S-SMG or remote gateway B3 approach makes multi-tenancy more achievable because the capability is concentrated in a cloud environment.

Savings may be significant given that rollout of such devices to each property may occur for tens of thousands or even millions of households.

A dedicated communications server of function B4 (either combined or separate from the remote gates B3) may handle communication links using a single transport certificate to represent traffic from a large number of local gateways B2.

Security: security may be improved, in particular for transfer over cable infrastructure, as the modulation inherent at the Physical layer provides additional protection.

To illustrate the cost saving, a rollout of a high functionality system (i.e. based on the prior art system 10 of claim 1) may be estimated at [symbol] 200 for each of 100,000 homes. For this system it is estimated that six certificates are needed per H-SMG B1 (covering transport security, signing data, key transport) meeting the required high level of national security requirements. These certificates may cost [symbol] 1 each, for example. These need to be renewed every 18 months, resulting [symbol] 4 per device p.a.

Costs of Existing System 10
a) H-SMG cost— [symbol] 20 m over rollout period
b) operational cost of certificates (estimated) [symbol] 400,000 p.a, once rollout completed.

Cost of System 100 (FIG. 2)
a) Local gateway B2 cost— [symbol] 1 m over rollout period
b) operational cost of certificates [symbol] 66,000 p.a. once rollout completed.

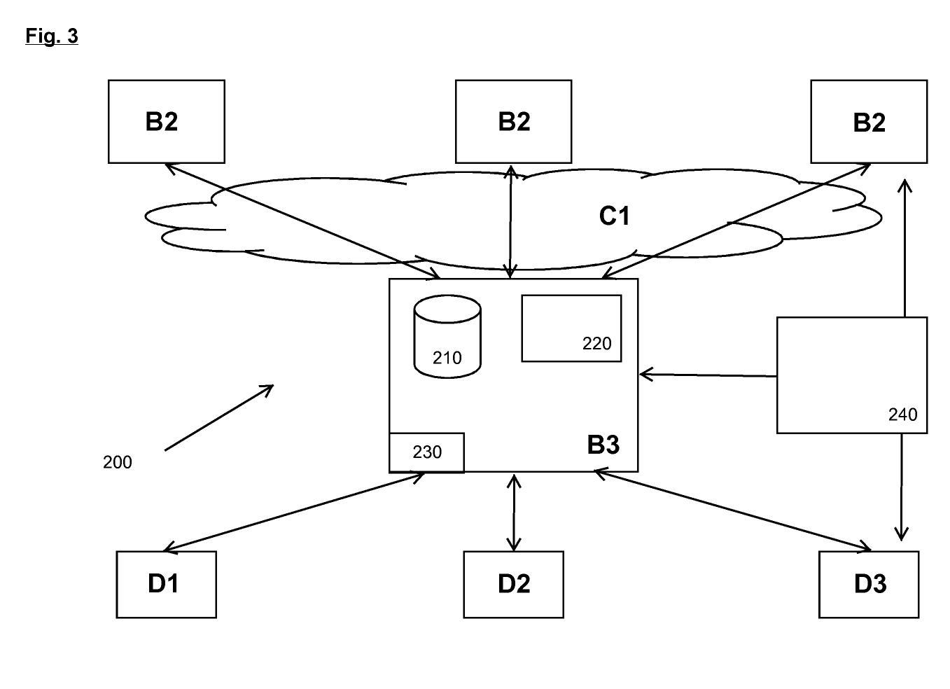

FIG. 3 shows a schematic diagram of the system 200 for managing utility meters and gateways. This figure shows the interaction between the remote gateway B3, a plurality of local gateways B2 over one or more WANs and utility management components D1, D2, D3. As described previously, there may be several remote gateways B3 operating on the system 200 but only one is shown on this figure.

The remote gateway B3 contains a data store 210 for storing static and dynamic data as well as obtained and generated certificates, for example. Parts of the data store may be highly secure, e.g. implemented on a hardware security module, representing an efficiency saving over storing the equivalent data in distributed secure elements in home gateways.

Processor 220 is used to execute the logic to implement the method and manage the data and devices. The remote gateway B3 also contains memory such as RAM 230. The functionality of the communications component or server B4 may be incorporated in to the remote gateway B3 or may be separate (not shown in this figure).

A certificate authority 240 may be used to generate digital certificates provided to the various components that require them. These digital certificates are provided to the remote gateway B3, the local gateways B2 and the utility management components D1, D2, D3.

Several certificate authorities 240 may be used and several instances of remote gateways B3 may be provided either at different parts of the network or within a single server, for example.

As will be appreciated by the skilled person, details of the above embodiment may be varied without departing from the scope of the present invention, as defined by the appended claims.

For example, utility meters and utility meter data has been described. However, other utility devices and utility data may be managed by the system and method. This may include devices to consume a utility (e.g. a boiler, heater, air conditioner, lighting, etc.) and the data may include control commands or usage information.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A remote gateway for managing a network of utility devices, the remote gateway forming part of a system comprising one or more utility management components, a plurality of local gateways each adapted to communicate with one or more utility devices, the remote gateway comprising logic configured to:
communicate utility data between the plurality of local gateways and the one or more utility management components over one or more secured wide area networks; and
manage digital certificates for certifying the communicated utility data.

2. The remote gateway of claim 1, wherein the logic is further configured to obtain digital certificates for securing the one or more WANs.

3. The remote gateway of claim 1, wherein each of the one or more local gateways is in communication with a group of the plurality of utility devices over a local network.

4. The remote gateway of claim 1, further configured to communicate with a server configured to secure a communication connection for communicating the utility data with the one or more utility management components.

5. The remote gateway of claim 4, wherein the logic is further configured to obtain one or more digital certificates for securing the communication connection with the one or more utility management components.

6. The remote gateway of claim 1, wherein the WAN is a cellular WAN or a cable WAN.

7. The remote gateway of claim 1, wherein the logic is further configured to create, procure, manage and/or delete digital certificates for the plurality of utility devices.

8. A system comprising:
a remote gateway according to claim 1;
one or more utility management components;
a server configured to secure a communication connection for communicating the utility data with the utility management components; and
a plurality of local gateways each adapted to communicate with one or more utility devices.

9. The system of claim 8, wherein the utility management components are any one or more of:
a data management component;
a system controller; and/or
a gateway configuration server.

10. The system of claim 8, wherein the remote gateway communicates with each local gateway over a secured WAN.

11. A method for managing a system comprising: a network of utility devices, a remote gateway adapted to communicate with a plurality of local gateways each adapted to communicate with one or more utility devices, and one or more utility management components, the method comprising the steps of:
communicating utility data between the plurality of local gateways and the one or more utility management components over one or more secured wide area networks; and
managing digital certificates for certifying the communicated utility data.

12. The method of claim 11, wherein the utility data are any one or more of:
meter readings, an instruction for a utility meter to provide a meter reading, measurement of energy supply quality, an instruction to switch a load, domestic generation data, an instruction to reduce or increase the level of domestic generation to the grid, current utility usage, historic utility usage, tariff level, utility bill data, and utility data upload schedule.

13. The method of claim 11 further comprising the step of generating key pairs for securing the one or more WANs.

14. The method of claim 11, wherein managing the digital certificates for certifying the utility data further comprises importing digital certificates from the one or more utility management components.

15. The method of claim 11 further comprising the step of procuring from a certificate authority digital certificates for signing, encrypting and/or authenticating the utility data.

16. The method of claim 11, wherein the utility devices are all or in part utility meters and further wherein the utility data are at least in part utility meter data.

17. A computer-readable medium carrying a computer program according to claim 11.
